(19) United States
(12) Patent Application Publication
(10) Pub. No.: US 2012/0076887 A1
(43) Pub. Date: Mar. 29, 2012

(54) MOULD HAVING CORE-PULLING MECHANISM

(75) Inventors: Xiao-ping Wu, Tu Cheng (TW); Shih-hsiung Ho, Tu Cheng (TW); Kun-hsueh Chiang, Tu Cheng (TW)

(73) Assignee: Cheng Uei Precision Industry Co., LTD., Taipei (TW)

(21) Appl. No.: 12/891,791

(22) Filed: Sep. 27, 2010

(51) Int. Cl. B29C 45/36

(52) U.S. Cl. 425/468

(57) ABSTRACT

A mould having core-pulling mechanism includes a core plate, a core insert, a cavity plate, a cavity insert, a guide dowel and a slide block. The cavity insert and the core insert define a mould cavity. A sliding groove of the core plate and a recess of the core insert are communicated with the mould cavity. The guide dowel is received in a dowel-receiving hole of the cavity plate and tiltedly extending out of the cavity plate. The slide block has an inserting block and a forming block. A lower portion of the slide block is slideably located in the sliding groove. The guide dowel can be inserted into an angle guiding hole of the slide block. The inserting block can be inserted into the recess. The forming block may enter into the mould cavity. The mould produces plastic products on the inner surface of which the groove is formed.

### BACKGROUND OF THE INVENTION

1.Field of the Invention

The present invention relates to a mould, and more particularly to a mould having core-pulling mechanism.

2. Description of the Prior Art

A plastic product is manufactured by a mould, which can be filled with the melting plastic material and can be opened after the melting plastic material is cooled to form the plastic product. Generally, when opening the mould having core-pulling mechanism, a slide block is pulled toward the outside of the mould for being disengaged with the plastic product molded in a mould cavity of the mould. The conventional mould having core-pulling mechanism is fit to manufacture the plastic product having a groove on an external surface thereof, but not fit to produce the plastic product, which forms a groove on an inner surface thereof facing to a mould core.

### BRIEF SUMMARY OF THE INVENTION

An object of the present invention is to provide a mould having core-pulling mechanism, which can produce a plastic product having a groove on an inner surface thereof facing to a mould core.

To achieve the above object, in accordance with the present invention, a mould having core-pulling mechanism is provided, comprising: a core plate, a core insert mounted on the core plate, a cavity plate, a cavity insert fixedly mounted on the cavity plate, a guide dowel and a slide block. The core plate disposes a sliding groove on a top surface thereof. The core insert disposes a recess on one side thereof. The cavity plate disposes a dowel-receiving hole. The cavity insert and the core insert define a mould cavity. The sliding groove and the recess are communicated with the mould cavity. The guide dowel is received in the dowel-receiving hole and is tiltedly extending outward from a bottom surface of the cavity plate. The slide block has a slide body and an inserting block protruding from one end surface of the slide body. The inserting block disposes a protruding block on one end thereof. The protruding block disposes a forming block extending toward the slide body. The slide body disposes an angle guiding hole formed on a top surface thereof. A lower portion of the slide block is slideably located in the sliding groove. The guide dowel is capable of being inserted into the angle guiding hole. The inserting block is capable of being inserted into the recess. The forming block is capable of entering into the mould cavity.

Based on the above description, a mould with replaceable mould core as provided by the present invention employs the slide block, which disposes the forming block extending toward the slide body. Under the action of the guide dowel, the slide block can slide toward the outside of the mould to make the forming block enter into the mould cavity when the mould is closed, and the slide block can slide toward the inside of the mould to make the forming block exit from the mould cavity when the mould is opened, so that the mould can produce the plastic product, on the inner surface of which the groove is formed.

### BRIEF DESCRIPTION OF THE DRAWINGS

FIG. 1a is an exploded perspective view of a mould having core-pulling mechanism according to one embodiment of the present invention;

FIG. 1b is an enlarged view of a slide block in FIG. 1a;

FIG. 2 is a partial sectional view of the mould having core-pulling mechanism of FIG. 1a before being closed or after being opened; and

FIG. 3 is a partial sectional view of the mould having core-pulling mechanism of FIG. 1a after being closed.

### DETAILED DESCRIPTION OF THE PREFERRED EMBODIMENTS

The following embodiment with reference to the accompanying drawings now has been given for detail describing the technology, the feature, the object and the effect of the present invention.

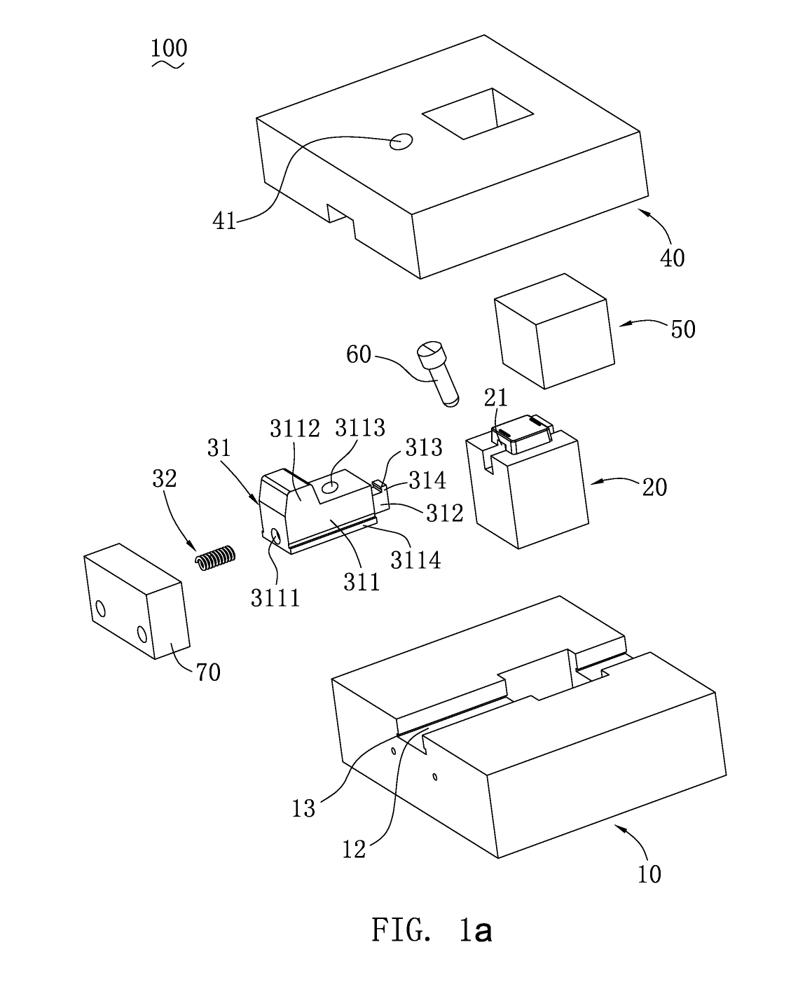

Please refer to FIG 1a, a mould 100 having core-pulling mechanism of the present invention is used to mold a plastic product having a groove on an inner surface thereof. The mould 100 having core-pulling mechanism comprises a core plate 10, a core insert 20 mounted on the core plate 10, a slide block 31, a spring 32, a cavity plate 40, a cavity insert 50 and a guide dowel 60 disposed on the cavity plate 40.

Please refer to FIGS. 1a, 2 and 3, the core insert 20 is fixedly mounted on the core plate 10. The core plate 10 disposes a sliding groove 12 formed on one side thereof, and a limiting groove 13, which is communicated with the bottom of the sliding groove 12 and the width of which is larger than that of the sliding groove 12. The cavity insert 50 is fixedly mounted on the cavity plate 40. The cavity insert 50 and the core insert 20 after being closed can define a mould cavity 11. The sliding groove 12 is communicated with the mould cavity 11. The core insert 20 forms a recess 21 on one side thereof, which is corresponding to the groove of the plastic product and is communicated with the mould cavity 11.

Please refer to FIG. 1b, the slide block 31 has a slide body 311 and an inserting block 312 protruding from one end surface of the slide body 311. The inserting block 312 disposes a protruding block 314 on one end thereof, which is extending upward. The protruding block 314 disposes a forming block 313 extending toward the slide body 311. The slide body 311 disposes a receiving recess 3111 formed on the other end surface thereof, a guiding block 3112 protruding from a top surface thereof and having a trapezoidal-shaped cross-section, an angle guiding hole 3113 formed on the top surface thereof, and two shoulders 3114, which are separately protruding from the lower portion of a front and rear surfaces thereof and are extending along the right and left directions.

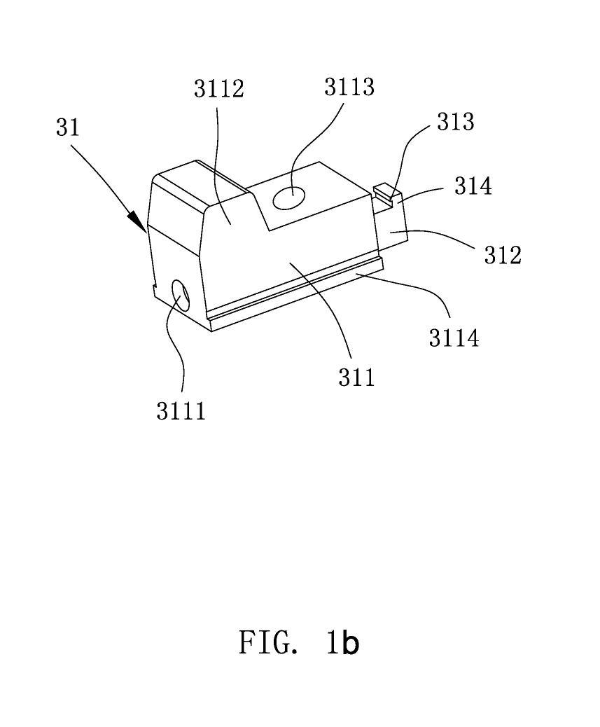

When assembling the mould 100 having core-pulling mechanism, the lower end of the slide block 31 is horizontally movable mounted in the sliding groove 12. The shoulders are slideably located in the limiting groove 13. Moreover, a slider blocking plate 70 is fixed on one end of the core plate 10, and forms a holding recess 701 (labeled in FIG. 2) corresponding to the sliding groove 12. The spring 32 is held between the holding recess 701 and the receiving recess 3111 of the slide block 31. The cavity plate 40 disposes a dowel-receiving hole 41. The guide dowel 60 is received in the dowel-receiving hole 41 and is tiltedly extending outward from a bottom surface of the cavity plate 40.

In one embodiment, if no external force exists, the spring 32 can push the slide block 31 toward a right side direction, so that a right side of the slide block 31 can press and depend upon the core insert 20, but the forming blocking is located outside of the mould cavity 11.

Referring to FIG. 2, before closing the mould 100, the slide block 31 may press and depend upon the core insert 20 toward the right side direction under the elastic function of the spring 32, the inserting block 312 is inserted into the recess 21, and the forming block 313 may press the core insert 20 and but not extend into the mould cavity 11.

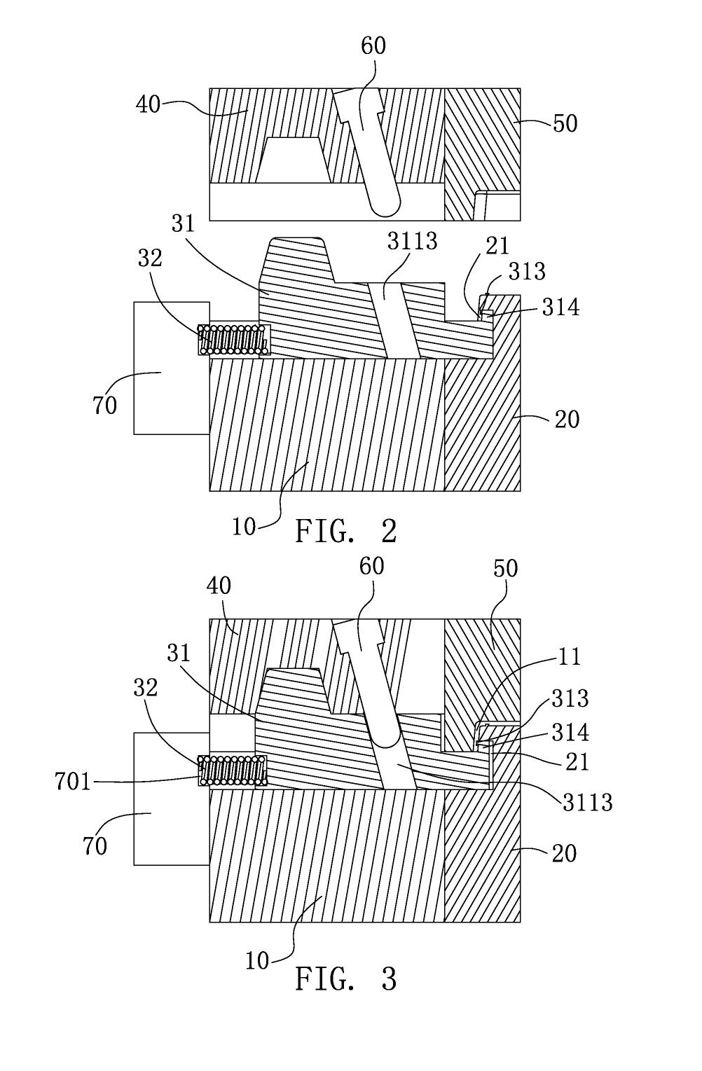

Referring to FIG. 3, when the mould 100 is closed, the cavity plate 40 and the core plate 10 are closed, and the cavity insert 50 and the core insert 20 are closed and commonly define the mould cavity 11. The lower end of the guide dowel 60 is tiltedly extending downward into the guiding groove 3113 for driving the slide block 31 to slide toward the left side direction, namely toward the outside of the mould 100, so that the forming block 3112 can enter into the mould cavity 11.

Then, the melting plastic material is fed into the mould cavity 11. When the melting plastic material is cooled in the mould 100 and the mould 100 is opened, the groove on the molding product can be formed at the location of the forming block 312 in the mould cavity 11. During opening the mould 100, the cavity plate 40 is move upward, and the guide dowel 60 tiltedly exits from the guiding groove 3113 and drives the slide block 31 to slide toward the right side direction. At the same time, the slide block 31 can slide toward the right side direction, namely toward the inside of the mould 100, under the elastic function of the spring 32, so that the forming block 313 can exit from the mould cavity 11 and the plastic product having been molded can be picked out.

As described above, the mould 100 having core-pulling mechanism of the present invention employs the slide block 31, which disposes the forming block 313 extending toward the slide body 311. Under the action of the guide dowel 60, the slide block 31 can slide toward the outside of the mould 100 to make the forming block 313 enter into the mould cavity 11 when the mould 100 is closed, and the slide block 31 can slide toward the inside of the mould 100 to make the forming block 313 exit from the mould cavity 11 when the mould 100 is opened, so that the mould 100 can produce the plastic product, on the inner surface of which the groove is formed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mould having core-pulling mechanism comprising:
a core plate, disposing a sliding groove on a top surface thereof;
a core insert, being mounted on the core plate and disposing a recess on one side thereof;
a cavity plate, disposing a dowel-receiving hole;
a cavity insert, being fixedly mounted on the cavity plate and defining a mould cavity together with the core insert, wherein the sliding groove and the recess are communicated with the mould cavity;
a guide dowel, being received in the dowel-receiving hole and tiltedly extending outward from a bottom surface of the cavity plate; and
a slide block, having a slide body and an inserting block protruding from one end surface of the slide body, wherein the inserting block disposes a protruding block on one end thereof, the protruding block disposes a forming block extending toward the slide body, the slide body disposes an angle guiding hole formed on a top surface thereof, a lower portion of the slide block is slideably located in the sliding groove, the guide dowel is capable of being inserted into the angle guiding hole, the inserting block is capable of being inserted into the recess, and the forming block is capable of entering into the mould cavity.

2. The mould having core-pulling mechanism as claimed in claim 1, further comprising a spring, which is held between the slide block and the core plate.

3. The mould having core-pulling mechanism as claimed in claim 2, wherein the slide body disposes a receiving recess on the other end surface thereof, a slider blocking plate is fixed on one end of the core plate and disposes a holding recess, and the spring is held between the holding recess and the receiving recess of the slide block.

4. The mould having core-pulling mechanism as claimed in claim 1, wherein the core plate disposes a limiting groove, which is communicated with the bottom of the sliding groove and the width of which is larger than that of the sliding groove, on an upper surface thereof; the slide body disposes two shoulders separately protruding from a lower portion of a front and rear surfaces thereof and both extending along the right and left directions; and the two shoulders are slideably located in the limiting groove.
